(19) United States
(12) Patent Application Publication
(10) Pub. No.: US 2026/0213650 A1
(43) Pub. Date: Jul. 23, 2026

(54) TOTEM POLE PFC CIRCUIT WITH EMI REDUCTION

(71) Applicant: Chengdu Monolithic Power Systems Co., Ltd., Chengdu (CN)

(72) Inventors: Guangzhuo Li, Hangzhou (CN); Youtu Lin, Hangzhou (CN); Jicheng Wang, Hangzhou (CN)

(21) Appl. No.: 19/456,933

(22) Filed: Jan. 22, 2026

(30) Foreign Application Priority Data
Jan. 23, 2025 (CN) 202510108522.1

(51) Int. Cl. H02M 1/44; H02M 1/00; H02M 1/08; H02M 1/088; H02M 1/42

(52) U.S. Cl. CPC H02M 1/44; H02M 1/0012; H02M 1/0029; H02M 1/083; H02M 1/088; H02M 1/4233

(57) ABSTRACT

A control circuit for a totem pole PFC circuit. The totem pole PFC circuit has a first half-bridge and a second half-bridge both coupled between an output terminal and a reference ground and converts an AC input voltage to an output voltage. The control circuit turns on a first switch or a second switch of the first half-bridge multiple times during a zero-crossing interval of the AC input voltage to gradually charge or discharge a switch node of the second half bridge.

### CROSS-REFERENCE TO RELATED APPLICATIONS

This application claims the benefit of CN application 202510108522.1, filed on January 23, 2025, and incorporated herein by reference.

### TECHNICAL FIELD OF THE INVENTION

The present invention generally relates to electronic circuits, and more particularly but not exclusively, to totem pole power factor correction (PFC) circuits.

### BACKGROUND OF THE INVENTION

Totem pole PFC circuits are widely used in the power supply field due to their advantages of low conduction loss and high circuit efficiency. Typically, a totem pole PFC circuit includes a first half-bridge with two high-frequency switches and a second half-bridge with two low-frequency switches. An alternating current (AC) input voltage can be converted to an output voltage to power a load by controlling the four switches.

However, at the zero-crossing point of the AC input voltage, the voltage at a switch node of the second half-bridge will rapidly transition between low level and high level within an extremely short time. For instance, when the AC input voltage crosses zero from positive to negative, the voltage at the switch node of the second half-bridge abruptly rises from 0V to 400V. Conversely, when the AC input voltage crosses zero from negative to positive, the voltage at the switch node of the second half-bridge abruptly drops from 400V to 0V. This not only results in poor electromagnetic interference (EMI) performance but also generates significant current spikes and common-mode currents, leading to audio noise.

Therefore, it is desired to provide a circuit that reduces the voltage slew rate (dV/dt) at the switch node of the second half-bridge.

### SUMMARY OF THE INVENTION

An embodiment of the present invention discloses a control circuit for a totem pole PFC circuit. The control circuit includes an input voltage sampling terminal, a zero-crossing detection circuit, a control signal generator and a first drive output terminal. The input voltage sampling terminal is configured to receive a sampling signal indicative of an AC input voltage of the totem pole PFC circuit. The zero-crossing detection circuit is configured to determine whether the AC input voltage is in a zero-crossing interval based on the sampling signal and configured to generate a zero-crossing indication signal to indicate whether the AC input voltage crosses zero. The control signal generator is configured to receive the zero-crossing indication signal and configured to generate a first control signal. The first drive output terminal is configured to provide the first control signal to a first switch of the totem pole PFC circuit. Where during a first time period after the AC input voltage crosses zero, the first control signal is configured to turn on the first switch multiple times with a first on time, and during a second time period after the AC input voltage crosses zero, the first control signal is configured to turn on the first switch multiple times with a second on time. Where the second time period is after the first time period, and the second on time is longer than the first on time.

An embodiment of the present invention discloses a control circuit for a totem pole PFC circuit. The control circuit includes an input voltage sampling terminal, a zero-crossing detection circuit, a control signal generator and a first drive output terminal. The input voltage sampling terminal is configured to receive a sampling signal indicative of an AC input voltage of the totem pole PFC circuit. The zero-crossing detection circuit is configured to determine whether the AC input voltage is in a zero-crossing interval based on the sampling signal and configured to generate a zero-crossing indication signal to indicate whether the AC input voltage crosses zero. The control signal generator is configured to receive the zero-crossing indication signal and configured to generate a first control signal. The first drive output terminal is configured to provide the first control signal to a first switch of the totem pole PFC circuit. Where during a first time period after the AC input voltage crosses zero, the first control signal is configured to turn on the first switch multiple times with a first switching frequency, and during a second time period after the AC input voltage crosses zero, the first control signal is configured to turn on the first switch multiple times with a second switching frequency. Where the second time period is after the first time period, and the second switching frequency is lower than the first switching frequency.

An embodiment of the present invention discloses a totem pole PFC circuit. The totem pole PFC circuit includes a first half-bridge, a second half-bridge, an inductor, a zero-crossing detection circuit and a control signal generator. The first half-bridge and the second half-bridge are both coupled between an output terminal and a reference ground, where the first half-bridge includes a first switch and a second switch, and the second half-bridge includes a third switch and a fourth switch. The inductor is coupled between a switch node of the first half-bridge and a first input terminal of the totem pole PFC circuit. The zero-crossing detection circuit is configured to determine whether an AC input voltage of the totem pole PFC circuit is in a zero-crossing interval based on a sampling signal indicative of the AC input voltage and configured to generate a zero-crossing indication signal to indicate whether the AC input voltage crosses zero. The control signal generator is configured to receive the zero-crossing indication signal and configured to generate a first control signal and a second control signal to control the first switch and the second switch respectively. Where during a first time period after the AC input voltage crosses zero, the first control signal is configured to turn on the first switch multiple times with a first on time, and during a second time period after the AC input voltage crosses zero, the first control signal is configured to turn on the first switch multiple times with a second on time. Where the second time period is after the first time period, and the second on time is longer than the first on time.

### BRIEF DESCRIPTION OF DRAWINGS

The present invention can be further understood with reference to the following detailed description and the appended drawings, wherein like elements are provided with like reference numerals.

FIG. 1 illustrates a totem pole PFC circuit 100 in accordance with an embodiment of the present invention.

FIG. 2 illustrates a working principle diagram of the totem pole PFC circuit 100 operating in normal operating mode in accordance with an embodiment of the present invention.

FIG. 3 illustrates a working principle diagram of the totem pole PFC circuit 100 operating in the pre-conduction mode in accordance with an embodiment of the present invention.

FIG. 4 illustrates a working waveform diagram of the totem pole PFC circuit 100 in accordance with an embodiment of the present invention.

FIG. 5 illustrates a working waveform diagram of the totem pole PFC circuit 100 in accordance with another embodiment of the present invention.

FIG. 6 illustrates a circuit schematic of a totem pole PFC circuit 100A in accordance with another embodiment of the present invention.

FIG. 7 illustrates a circuit schematic of a zero-crossing detection circuit 120B in accordance with an embodiment of the present invention.

FIG. 8 illustrates a circuit schematic of a zero-crossing detection circuit 120C in accordance with another embodiment of the present invention.

FIG. 9 illustrates a circuit schematic of an on time control circuit 121A in accordance with an embodiment of the present invention.

FIG. 10 illustrates a circuit schematic of an on time control circuit 121B in accordance with another embodiment of the present invention.

FIG. 11(a) illustrates a relationship diagram between the feedback signal Vfb indicative of the voltage at the switch node SW2 and the first control signal G1 in accordance with an embodiment of the present invention.

FIG. 11(b) illustrates a relationship diagram between the feedback signal Vfb and the second control signal G2 in accordance with another embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to "one embodiment", "an embodiment", "an example" or "examples" means: certain features, structures, or characteristics are contained in at least one embodiment of the present invention. These "one embodiment", "an embodiment", "an example" and "examples" are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as "connected" or "coupled" to another element, it can be directly connected or coupled to the other element, or there could exist one or more intermediate elements. In contrast, when an element is referred to as "directly connected" or “directly coupled” to another element, there is no intermediate element.

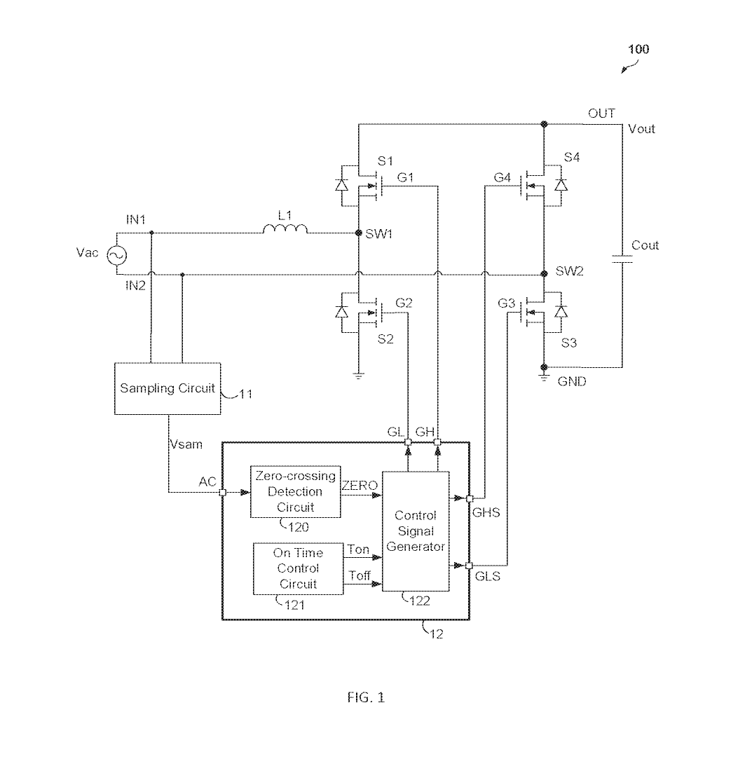

FIG. 1 illustrates a totem pole PFC circuit 100 in accordance with an embodiment of the present invention. As shown in FIG. 1, the totem pole PFC circuit 100 includes a first input terminal IN1 and a second input terminal IN2 for receiving an AC input voltage Vac, an output terminal OUT and a reference ground GND for providing an output voltage Vout, and a first half-bridge, a second half-bridge and an output capacitor Cout all coupled between the output terminal OUT and the reference ground GND. The first half-bridge is coupled to an inductor L1 and includes a first switch S1 and a second switch S2, the second half-bridge includes a third switch S3 and a fourth switch S4. In the example shown in FIG. 1, the first switch S1 is coupled between the output terminal OUT and a switch node SW1 of the first half-bridge, the second switch S2 is coupled between the switch node SW1 and the reference ground GND, the third switch S3 is coupled between a switch node SW2 of the second half-bridge and the reference ground GND, the fourth switch S4 is coupled between the output terminal OUT and the switch node SW2, and the inductor L1 is coupled between the switch node SW1 of the first half-bridge and the first input terminal IN1 of the totem pole PFC circuit 100.

In the example shown in FIG. 1, switches S1-S4 are all metal-oxide-semiconductor field-effect transistors (MOSFETs). In other embodiments, switches S1-S4 may be other suitable controllable switches, such as Junction Field-Effect Transistors (JFETs) and Insulated-Gate Bipolar Transistors (IGBTs). In some embodiments, the first switch S1 and the second switch S2 are wide-bandgap (WBG) semiconductor switches and operate at high switching frequencies. In one embodiment, the WBG semiconductor switches include silicon carbide (SiC) material. In another embodiment, the WBG semiconductor switch includes gallium nitride (GaN) material. In other embodiments, the WBG semiconductor switch includes WBG semiconductor materials with a bandgap greater than that of silicon, such as diamond, III-V semiconductor materials, and II-VI semiconductor materials.

As shown in FIG. 1, a control circuit 12 is configured to control the totem pole PFC circuit 100. A sampling circuit 11 is coupled to the first input terminal IN1 and the second input terminal IN2 to receive the AC input voltage Vac and generates a sampling signal Vsam indicative of the AC input voltage Vac. In one embodiment, the control circuit 12 is an integrated circuit. The control circuit 12 includes a plurality of terminals, a zero-crossing detection circuit 120 and a control signal generator 122. For example, the plurality of terminals include an input voltage sampling terminal AC, a first drive output terminal GH, a second drive output terminal GL, a third drive output terminal GLS and a fourth drive output terminal GHS. The input voltage sampling terminal AC is coupled to the sampling circuit 11 to receive the sampling signal Vsam indicative of the AC input voltage Vac. The zero-crossing detection circuit 120 determines whether the AC input voltage Vac is in a zero-crossing interval based on the sampling signal Vsam and generates a zero-crossing indication signal ZERO to indicate that the AC input voltage Vac crosses zero. In some embodiments, when the sampling signal Vsam indicates that the AC input voltage Vac is lower than a positive voltage threshold Vth1 and higher than a negative voltage threshold Vth2, the zero-crossing detection circuit 120 determines that the AC input voltage Vac is in the zero-crossing interval (i.e., Vth2<Vac<Vth1). In one embodiment, the positive voltage threshold Vth1 is a value higher than zero (e.g., 10V), and the negative voltage threshold Vth2 is a value lower than zero (e.g., -10V). In one embodiment, the absolute values of the positive voltage threshold Vth1 and the negative voltage threshold Vth2 are equal. In another embodiment, the absolute values of the positive voltage threshold Vth1 and the negative voltage threshold Vth2 are different, such as |Vth1| < |Vth2|.

The control signal generator 122 receives the zero-crossing indication signal ZERO and generates a first control signal G1, a second control signal G2, a third control signal G3 and a fourth control signal G4. The first drive output terminal GH provides the first control signal G1 to the first switch S1. The second drive output terminal GL provides the second control signal G2 to the second switch S2. The third drive output terminal GLS provides the third control signal G3 to the third switch S3. The fourth drive output terminal GHS provides the fourth control signal G4 to the fourth switch S4.

In the example shown in FIG. 1, the control circuit 12 further includes an on time control circuit 121 for generating an on time signal Ton and an off time signal Toff to control the on time ton and the off time toff of either the first switch S1 or the second switch S2. In one embodiment, when the zero-crossing indication signal ZERO indicates that the AC input voltage Vac crosses zero from positive to negative, the control signal generator 122 generates the first control signal G1 based on the on time signal Ton and the off time signal Toff. In another embodiment, when the zero-crossing indication signal ZERO indicates that the AC input voltage Vac crosses zero from negative to positive, the control signal generator 122 generates the second control signal G2 based on the on time signal Ton and the off time signal Toff.

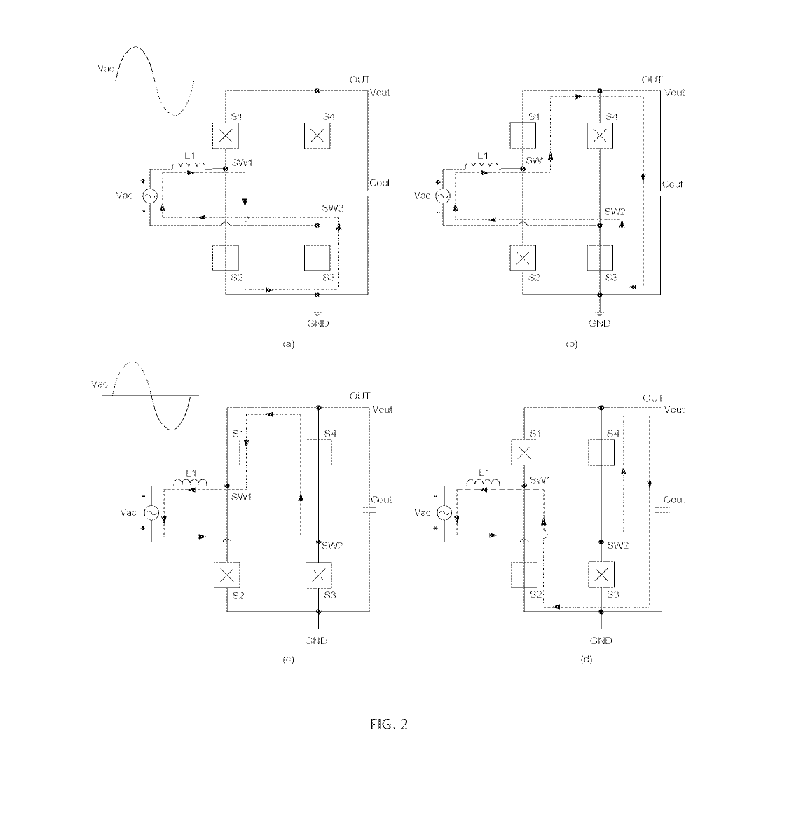

In some embodiments, when the zero-crossing detection circuit 120 determines that the AC input voltage Vac is not in the zero-crossing interval, the control circuit 12 controls the totem pole PFC circuit 100 to operate in normal operating mode. FIG. 2 illustrates a working principle diagram of the totem pole PFC circuit 100 operating in normal operating mode in accordance with an embodiment of the present invention. Specifically, FIG. 2(a) and FIG. 2(b) illustrate the working principle of the totem pole PFC circuit 100 when the AC input voltage Vac is in the positive half-cycle; FIG. 2(c) and FIG. 2(d) illustrate the working principle of the totem pole PFC circuit 100 when the AC input voltage Vac is in the negative half-cycle.

The working principle of the totem pole PFC circuit 100 is identical to that of a boost circuit. Specifically, in FIG. 2(a) and FIG. 2(b), the third switch S3 keeps on, the fourth switch S4 keeps off, and the first switch S1 and the second switch S2 are turned on and turned off alternately. As shown in FIG. 2(a), when the first switch S1 is off and the second switch S2 is on, the inductor L1 in the totem pole PFC circuit 100 stores energy. An inductor current increases and flows through the inductor L1, the second switch S2, and then through the third switch S3. At this time, the voltages at the switch nodes SW1 and the switch nodes SW2 both equal the reference ground voltage. As shown in FIG. 2(b), when the first switch S1 is on and the second switch S2 is off, the inductor L1 in the totem pole PFC circuit 100 releases energy. The inductor current decreases and flows through inductor L1, the first switch S1, the output capacitor Cout, and then through the third switch S3. At this time, the voltage at the switch node SW1 equals the output voltage Vout, and the voltage at the switch node SW2 equals the reference ground voltage.

In FIG. 2(c) and FIG. 2(d), the third switch S3 keeps off, the fourth switch S4 keeps on, and the first switch S1 and the second switch S2 are turned on and turned off alternately. As shown in FIG. 2(c), when the first switch S1 is on and the second switch S2 is off, the inductor L1 in the totem pole PFC circuit 100 stores energy. The inductor current increases and flows through the fourth switch S4, the first switch S1, and then through the inductor L1. At this time, the voltages at the switch nodes SW1 and the switch nodes SW2 both equal the output voltage Vout. As shown in FIG. 2(d), when the first switch S1 is off and the second switch S2 is on, the inductor L1 in the totem pole PFC circuit 100 releases energy. The inductor current decreases and flows through the fourth switch S4, the output capacitor Cout, the second switch S2, and then through the inductor L1. At this time, the voltage at the switch node SW1 equals the reference ground voltage, and the voltage at the switch node SW2 equals the output voltage Vout.

As shown above, when the AC input voltage Vac is in the positive half-cycle, the third switch S3 keeps on, and the voltage at the switch node SW2 of the second half-bridge is at a low level (e.g., the reference ground voltage). When the AC input voltage Vac is in the negative half-cycle, the third switch S3 keeps off, and the voltage at the switch node SW2 of the second half-bridge is at a high level (e.g., the output voltage Vout). Therefore, when the AC input voltage Vac transitions from the positive half-cycle to the negative half-cycle, the voltage at the switch node SW2 of the second half-bridge switches from the low level to the high level. When the AC input voltage Vac transitions from the negative half-cycle to the positive half-cycle, the voltage at the switch node SW2 of the second half-bridge switches from the high level to the low level.

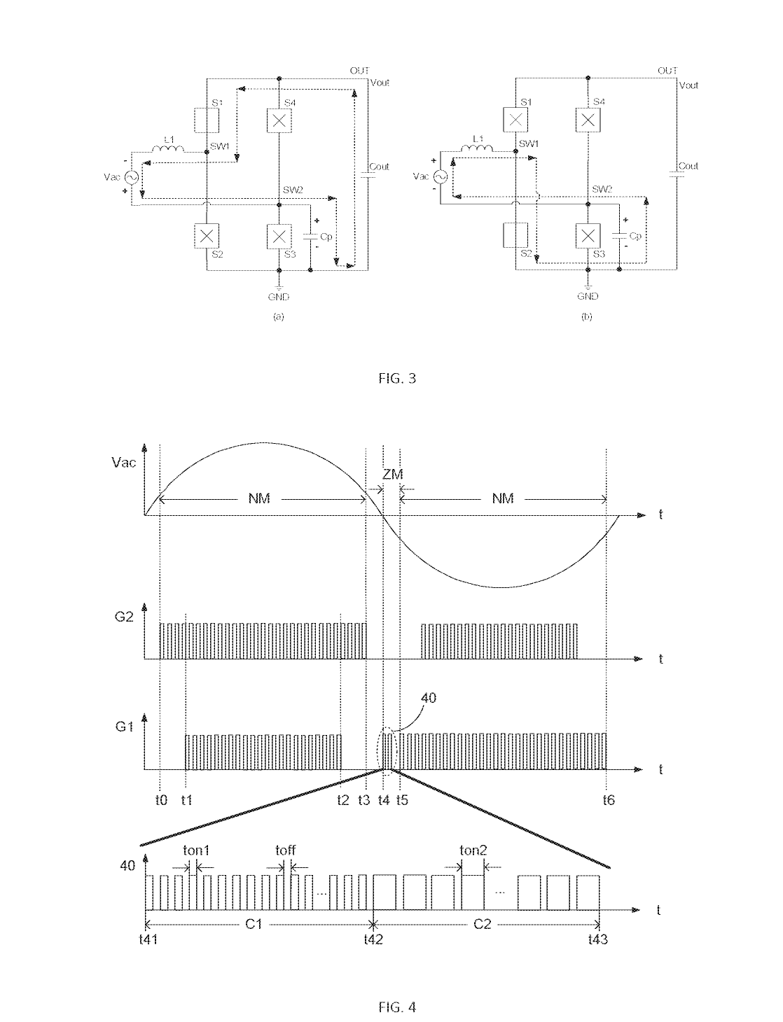

In other embodiments, when the zero-crossing detection circuit 120 detects that the AC input voltage Vac crosses zero, the control circuit 12 controls the totem pole PFC circuit 100 to operate in a pre-conduction mode. When the totem pole PFC circuit 100 operates in the pre-conduction mode, the control circuit 12 controls the first switch S1 or the second switch S2 to turn on multiple times to charge or discharge the switch node SW2 of the second half-bridge. FIG. 3 illustrates a working principle diagram of the totem pole PFC circuit 100 operating in the pre-conduction mode in accordance with an embodiment of the present invention. Specifically, FIG. 3(a) shows the working principle of the totem pole PFC circuit 100 after the AC input voltage Vac crosses zero from positive to negative, and FIG. 3(b) shows the working principle of the totem pole PFC circuit 100 after the AC input voltage Vac crosses zero from negative to positive. In the example shown in FIG. 3, a capacitor Cp represents the parasitic capacitance of the third switch S3. In other embodiments, the capacitor Cp is an independent capacitor coupled in parallel with the third switch S3 to further reduce the voltage slew rate at the switch node SW2. In one embodiment, the capacitance value of the capacitor Cp ranges from 100nF to 1μF.

Specifically, in FIG. 3(a), the third switch S3 keeps off, causing the switch node SW2 to be disconnected from the reference ground GND. The first switch S1 is turned on to increase the voltage at the switch node SW2. When the first switch S1 is on, the inductor current flows through the switch node SW2, the capacitor Cp, the output capacitor Cout, the first switch S1, and then through the inductor L1. The switch node SW2 is charged, and the voltage at the switch node SW2 increases. In FIG. 3(b), the third switch S3 keeps off, causing the switch node SW2 to be disconnected from the reference ground GND. The second switch S2 is turned on to reduce the voltage at the switch node SW2. When the second switch S2 is turned on, the inductor current flows through the inductor L1, the second switch S2, the capacitor Cp, and then the switch node SW2. The switch node SW2 is discharged, and the voltage at switch node SW2 decreases.

Since the working principle of the totem pole PFC circuit 100 when the AC input voltage Vac crosses zero from positive to negative is similar with the working principle of the totem pole PFC circuit 100 when the AC input voltage Vac crosses zero from negative to positive, the following embodiments take the positive to negative zero-crossing transition as an example for simplicity. In this case, the control circuit 12 controls the first switch S1 to turn on multiple times.

FIG. 4 illustrates a working waveform diagram of the totem pole PFC circuit 100 in accordance with an embodiment of the present invention. The working principle of the control circuit 12 will be described below with reference to FIG. 1 and FIG. 4. In the example shown in FIG. 4, a high level control signal G1/G2 controls the switch S1/S2 to turn on, and a low level control signal G1/G2 controls the switch S1/S2 to turn off. In other words, the on time ton of the switch S1/S2 corresponds to the high level duration of the control signal G1/G2, and the off time toff of the switch S1/S2 corresponds to the low level duration of the control signal G1/G2. In another embodiment, the on time ton of the switch S1/S2 may correspond to the low level duration of the control signal G1/G2, and the off time toff of the switch S1/S2 may correspond to the high level duration of the control signal G1/G2. In some embodiments of the present invention, the on time ton of the switch S1/S2 is also referred to as the on time ton of the control signal G1/G2, the off time toff of the switch S1/S2 is also referred to as the off time toff of the control signal G1/G2.

When the sampling signal Vsam indicates that the AC input voltage Vac is in the positive half-cycle (e.g., during time period t0-t3) or in the negative half-cycle (e.g., during time period t5-t6), the totem pole PFC circuit 100 operates in the normal operating mode NM, the working principle is shown in FIG. 2.

When the sampling signal Vsam indicates that the AC input voltage Vac is higher than the positive voltage threshold Vth1, the AC input voltage Vac is in the positive half-cycle, the totem-pole PFC circuit 100 operates in the normal operating mode NM. The first control signal G1 and the second control signal G2 control the first switch S1 and the second switch S2 to be turned on and turned off alternately. When the AC input voltage Vac is low, the decreasing rate of the inductor current during the conduction of the first switch S1 is significantly greater than the increasing rate of the inductor current during the conduction of the second switch S2. If the first switch S1 and the second switch S2 are turned on alternately, the inductor current may decrease to a value lower than zero. To prevent the inductor current from decreasing below zero, in the example shown in FIG. 4, when the AC input voltage Vac is low (e.g., during time periods t0-t1 and t2-t3), the first control signal G1 controls the first switch S1 to keep off, and the second control signal G2 controls the second switch S2 to be turned on and off.

As shown in FIG. 4, at time t0, the second control signal G2 starts to switch between the high level and the low level, and the second switch S2 starts to be turned on and off. At time t1, the first control signal G1 starts to switch between the high level and the low level, and the first switch S1 starts to be turned on and off. At time t2, the first control signal G1 switches to the low level and then keeps low level, and the first switch S1 keeps off. After time t2, the second control signal G2 controls the second switch S2 to be turned on multiple times. At time t3, the sampling signal Vsam indicates that the AC input voltage Vac is lower than the positive voltage threshold Vth1, the AC input voltage Vac enters the zero-crossing interval. The second control signal G2 switches to the low level and then keeps low level, and the second switch S2 keeps off.

When the zero-crossing indication signal ZERO indicates that the AC input voltage Vac crosses zero from positive to negative (e.g., during time period t4-t5), the totem-pole PFC circuit 100 enters the pre-conduction mode ZM. The detailed working principle is illustrated in FIG. 3(a). Specifically, the first control signal G1 controls the first switch S1 to be turned on multiple times (as shown in FIG. 4, region 40), the second control signal G2 keeps the second switch S2 off, thereby gradually charging the voltage at the switch node SW2.

At time t4, when the zero-crossing indication signal ZERO indicates the AC input voltage Vac crosses zero from positive to negative, the first control signal G1 switches to the high level to turn on the first switch S1.

At time t5, when the sampling signal Vsam indicates that the AC input voltage Vac is lower than the negative voltage threshold Vth2, the AC input voltage Vac exits the zero-crossing interval and enters the negative half-cycle, the totem-pole PFC circuit 100 operates in the normal operating mode NM. The detailed working principle of the normal operating mode NM in the negative half-cycle is similar to that in the positive half-cycle and thus is not repeated here.

At time t6, when the sampling signal Vsam indicates that the AC input voltage Vac is higher than the negative voltage threshold Vth2, the AC input voltage Vac enters the zero-crossing interval. The first control signal G1 switches to the low level and then keeps low level, and the first switch S1 keeps off.

The working principle of the pre-conduction mode ZM is shown as region 40. In the example shown in FIG. 4, the pre-conduction mode ZM can be divided into multiple cycles (e.g., a first cycle C1 and a second cycle C2). Where the first switch S1 has a shorter on time ton during the first cycle C1 and a longer on time ton during the second cycle C2. Simultaneously, the first switch S1 has a higher switching frequency during the first cycle C1 and a lower switching frequency during the second cycle C2. As shown in FIG. 3(a), the switch node SW2 is charged during the conduction period of the first switch S1. Therefore, the voltage increment at the switch node SW2 during each conduction of the first switch S1 is determined by the on time ton of the first switch S1. For example, when the on time ton of the first switch S1 is 50ns, the voltage increment at the switch node SW2 during each conduction of the first switch S1 is 1V. When the on time ton of the first switch S1 is 100ns, the voltage increment at the switch node SW2 during each conduction of the first switch S1 is 2V. Since the first switch S1 has the shorter on time ton during the first cycle C1, the voltage at the switch node SW2 can increase with a smaller increment, thereby achieving a reduced voltage slew rate at the switch node SW2. Simultaneously, the first switch S1 has the higher switching frequency during the first cycle C1, consequently, the first switch S1 can be turned on multiple times during the first cycle C1, enabling the voltage at the switch node SW2 to gradually increase to a certain value close to the output voltage Vout (e.g., increasing from 0V to 350V). In other words, during the first cycle C1, the shorter on time ton ensures the smaller increment in the voltage at the switch node SW2, while the higher switching frequency ensures that the voltage at the switch node SW2 can be gradually increased to the certain value.

Next, since the first switch S1 has the longer on time ton during the second cycle C2, the voltage at the switch node SW2 increases at a larger increment, accelerating the entire charging process. This ensures that the switch node SW2 can be charged to the target value (e.g., the output voltage Vout) before the AC input voltage Vac exits the zero-crossing interval (e.g., at time t5). In the example shown in FIG. 4, since the voltage at the switch node SW2 has already been charged to the certain value close to the output voltage Vout during the first cycle C1, in other words, the voltage at the switch node SW2 has been already near the output voltage Vout when the totem pole PFC circuit 100 enters the second cycle C2, even if the second cycle C2 has the larger on time ton, it does not affect the EMI performance of the totem pole PFC circuit 100.

For example, during the first cycle C1(e.g., during a first time period t41-t42) after the AC input voltage Vac crosses zero, the first control signal G1 controls the first switch S1 to be turned on multiple times with a first on time ton1 and a first switching frequency f1. During the second cycle C2(e.g., during a second time period t42-t43) after the AC input voltage Vac crosses zero, the first control signal G1 controls the first switch S1 to be turned on multiple times with a second on time ton2 and a second switching frequency f2. Where the second time period t42-t43 is after the first time period t41-t42, the second on time ton2 is longer than the first on time ton1 and the second switching frequency f2 is lower than the first switching frequency f1. In the example shown in FIG. 4, the off time toff of the first switch S1 keeps constant during the first time period t41-t42 and the second time period t42-t43.

According to the embodiment of the present invention, the first switch S1 or the second switch S2 is turned on multiple times with the higher frequency and the shorter on time during the first time period after the AC input voltage Vac crosses zero. This gradually charges/discharges the voltage at the switch node SW2, thereby reducing the voltage slew rate at the switch node SW2, improves the EMI performance and reduces audio noise. In addition, the first switch S1 or the second switch S2 is turned on multiple times with the lower frequency and the longer on time during the second time period after the AC input voltage Vac crosses zero. This accelerates the entire charging/discharging process, ensuring that the voltage at the switch node SW2 can be charged/discharged to the target value before the AC input voltage Vac exits the zero-crossing interval.

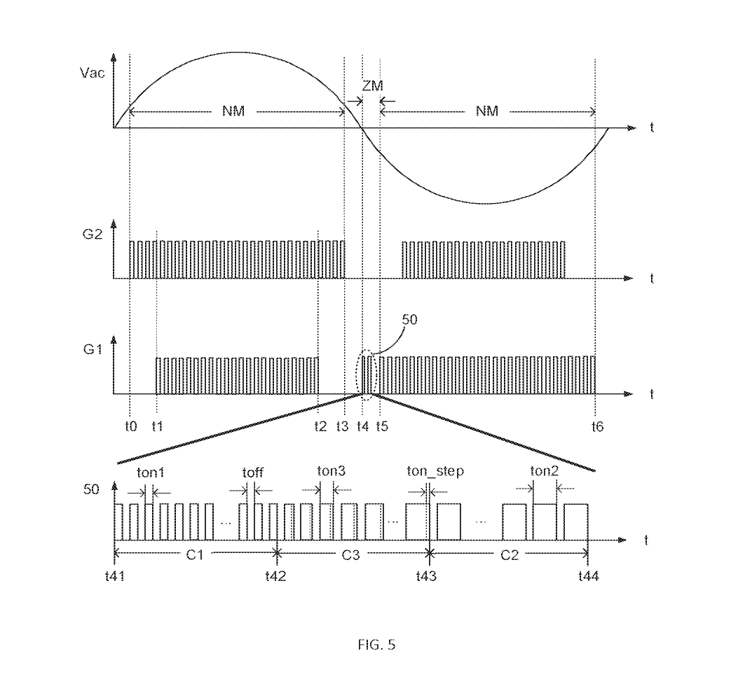

FIG. 5 illustrates a working waveform diagram of the totem pole PFC circuit 100 in accordance with another embodiment of the present invention. Different form the example shown in FIG. 4, the pre-conduction mode ZM further includes a transition cycle. For example, the pre-conduction mode ZM further includes a third cycle C3 between the first cycle C1 and the second cycle C2. During the third cycle C3, the on time ton of the first control signal G1 gradually increases. In other words, during the third cycle C3, the switching frequency of the first control signal G1 gradually decreases. Compared to the example shown in FIG. 4, the transition period in the example shown in FIG. 5 can avoid noise issues caused by abrupt change in the on time ton and the switching frequency of the first control signal G1 between the first cycle C1 and the second cycle C2, thereby further improving the EMI performance.

For example, during the third cycle C3 (e.g., during the third time period t42-t43) after the AC input voltage Vac crosses zero, the on time ton of the first control signal G1 gradually increases from ton1 to ton2. In other words, the switching frequency of the first control signal G1 gradually decreases from the first switching frequency f1 to the second switching frequency f2. In one embodiment, during the third cycle C3, the first control signal G1 turns on the first switch S1 with a third on time ton3 and a third switching frequency f3. The third on time ton3 is longer than the first on time ton1 and shorter than the second on time ton2. The third switching frequency f3 is lower than the first switching frequency f1 and higher than the second switching frequency f2.

In one embodiment, during the third time period t42-t43, the on time ton of the first switch S1 increases by a fixed step value ton_step. In the example shown in FIG. 5, the off time toff of the first control signal G1 remains constant during the first, second, and third time periods. In one embodiment, during the first cycle C1, the on time ton1 of the first control signal G1 is 200ns. During the third cycle C3, the on time ton3 of the first control signal G1 gradually increases from 200ns to 1.5μs. During the second cycle C2, the on time ton2 of the first control signal G1 is 1.5μs. In one embodiment, during the first cycle C1, the voltage at the switch node SW2 increases from 0V to 160V in a 20V increment. During the third cycle C3, the voltage at the switch node SW2 increases from 160V to 200V. During the second cycle C2, the voltage at the switch node SW2 increases from 200V to 400V in a 25V increment. Those skilled in the art can understood that the on time, the switching frequency, and the number of turn-on times of the first switch S1 during the first, second, and third cycles may be set based on the specific circuit parameters and requirements of practical applications. In some embodiments, the first on time ton1 is shorter than 1μs. In one embodiment, the first on time ton1 ranges from 50ns to 200ns. In some embodiments, the second on time ton2 ranges from 1μs to 10μs. In some embodiments, the first switching frequency f1 is higher than 200kHz. In one embodiment, the second switching frequency f2 is 100kHz.

In some embodiments, when the sampling signal Vsam indicates that the AC input voltage Vac is in the zero-crossing interval (e.g., during the time period t3-t5), the first switch S1 ceases conduction when the number of the conduction times of the first switch S1 reaches a preset value, i.e., when the voltage at the switch node SW2 increases to the output voltage Vout. As shown in FIG. 5, at time t44, the first control signal G1 switches to the low level to keep the first switch S1 off until the sampling signal Vsam indicates that the AC input voltage Vac exits the zero-crossing interval. For example, at time t5, the first control signal G1 switches to the high level, the first switch S1 is turned on, and the totem pole PFC circuit 100 enters the normal operating mode NM.

In some embodiments, the pre-conduction mode may include additional cycles. For example, the pre-conduction mode may have n cycles, each with a fixed on time ton_i, where the on time of each cycle is longer than that of the preceding cycle, i.e., ton_1<ton_2<...<ton_i<...<ton_n. In another embodiment, the pre-conduction mode has n cycles, where at least one cycle has a progressively increasing on time, while the remaining cycles have a fixed on time, where the on time of each cycle is longer than that of the preceding cycle.

FIG. 6 illustrates a circuit schematic of a totem pole PFC circuit 100A in accordance with another embodiment of the present invention. In the example shown in FIG. 6, the totem pole PFC circuit 100A includes a sampling circuit 11A and a control circuit 12A. As shown in FIG. 6, the sampling circuit 11A includes resistors R1-R4, where a common connection node of resistors R1 and R2 provides a first sampling signal Vsam1, and a common connection node of resistors R3 and R4 provides a second sampling signal Vsam2. The control circuit 12A includes a plurality of terminals, a zero-crossing detection circuit 120A, an on time control circuit 121, and a control signal generator 122A. Different from the example shown in FIG. 1, in the example shown in FIG. 6, the plurality of terminals includes an input voltage sampling terminal ACL, an input voltage sampling terminal ACN, and a detection terminal SWN. The input voltage sampling terminal ACL is coupled to the common connection node of resistors R1 and R2 to receive the first sampling signal Vsam1, and the input voltage sampling terminal ACN is coupled to the common connection node of resistors R3 and R4 to receive the second sampling signal Vsam2. The detection terminal SWN receives a feedback signal Vfb indicative of the voltage at the switch node SW2. In one embodiment, the voltage at the switch node SW2 may be directly provided to the control circuit 12A as the feedback signal Vfb. In another embodiment, the totem pole PFC circuit 100A further includes a voltage divider circuit that divides the voltage at the switch node SW2 and provides the divided voltage of the voltage at the switch node SW2 to the control circuit 12A as the feedback signal Vfb.

The zero-crossing detection circuit 120A determines whether the AC input voltage Vac is in the zero-crossing interval based on the first sampling signal Vsam1 and the second sampling signal Vsam2, and generates the zero-crossing indication signal ZERO to indicate whether the AC input voltage Vac crosses zero.

The on time control circuit 121 provides the on time signal Ton and the off time signal Toff. The control signal generator 122A receives the zero-crossing indication signal ZERO, the on time signal Ton, the off time signal Toff and the feedback signal Vfb and generates the first control signal G1, the second control signal G2, the third control signal G3 and the fourth control signal G4. In some embodiments, when the control circuit 12 controls the totem pole PFC circuit 100A to operate in the pre-conduction mode, the control signal generator 122A generates the first control signal G1 based on the on time signal Ton, the off time signal Toff and the feedback signal Vfb. In one embodiment, during the zero-crossing interval, when the feedback signal Vfb reaches a reference voltage Vref, the control signal generator 122A generates the first control signal G1 to keep the first switch S1 off.

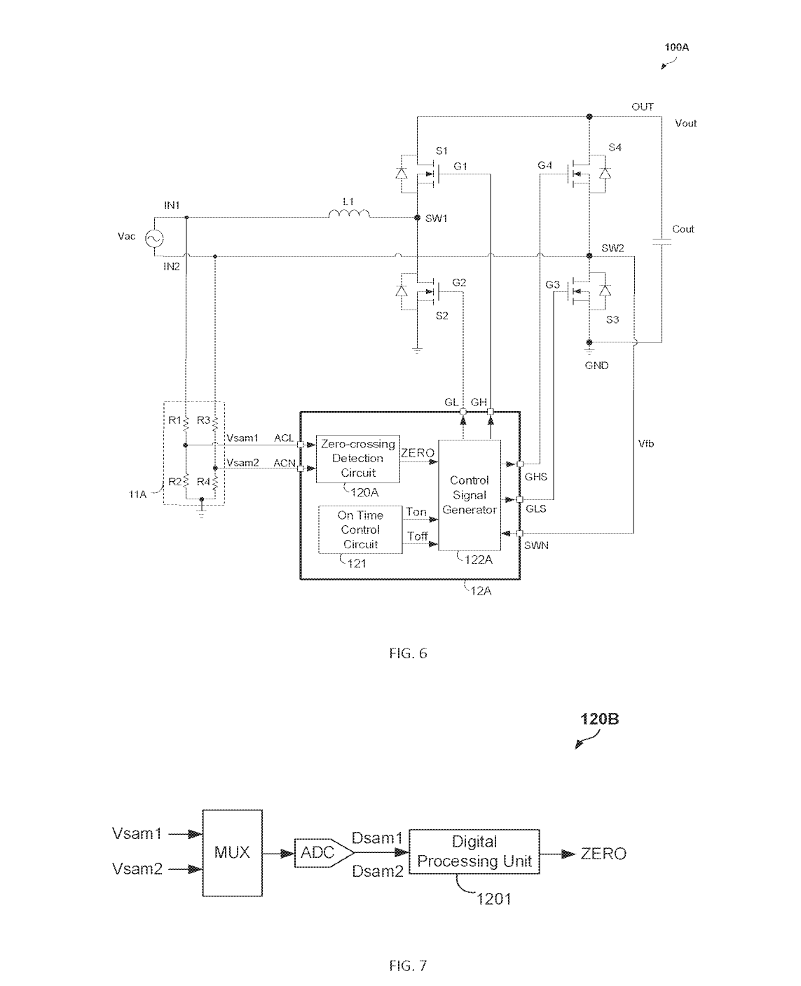

FIG. 7 illustrates a circuit schematic of a zero-crossing detection circuit 120B in accordance with an embodiment of the present invention. As shown in FIG. 7, the zero-crossing detection circuit 120B includes a multiplexer MUX, an analog-to-digital converter ADC and a digital processing unit 1201. The multiplexer MUX has a first input terminal, a second input terminal and an output terminal. The first input terminal receives the first sampling signal Vsam1, and the second input terminal receives the second sampling signal Vsam2. The multiplexer provides the first sampling signal Vsam1 or the second sampling signal Vsam2 to the output terminal of the multiplexer MUX in a time-sharing manner. Where the first sampling signal Vsam1 represents the voltage at the first input terminal IN1 of the totem pole PFC circuit 100A, and the second sampling signal Vsam2 represents the voltage at the second input terminal IN2 of the totem pole PFC circuit 100A. The analog-to-digital converter ADC is coupled to the output terminal of the multiplexer MUX and converts the first sampling signal Vsam1 and the second sampling signal Vsam2 to a first digital signal Dsam1 and a second digital signal Dsam2 respectively. The digital processing unit 1201 is coupled to the analog-to-digital converter ADC and provides the zero-crossing indication signal ZERO based on the first digital signal Dsam1 and the second digital signal Dsam2. In one embodiment, when the AC input voltage Vac crosses zero, the value of the first sampling signal Vsam1 is equal to the value of the second sampling signal Vsam2, the difference between the first digital signal Dsam1 and the second digital signal Dsam2 is zero, and the digital processing unit 1201 provides the zero-crossing indication signal ZERO in the high level to indicate that the AC input voltage Vac crosses zero.

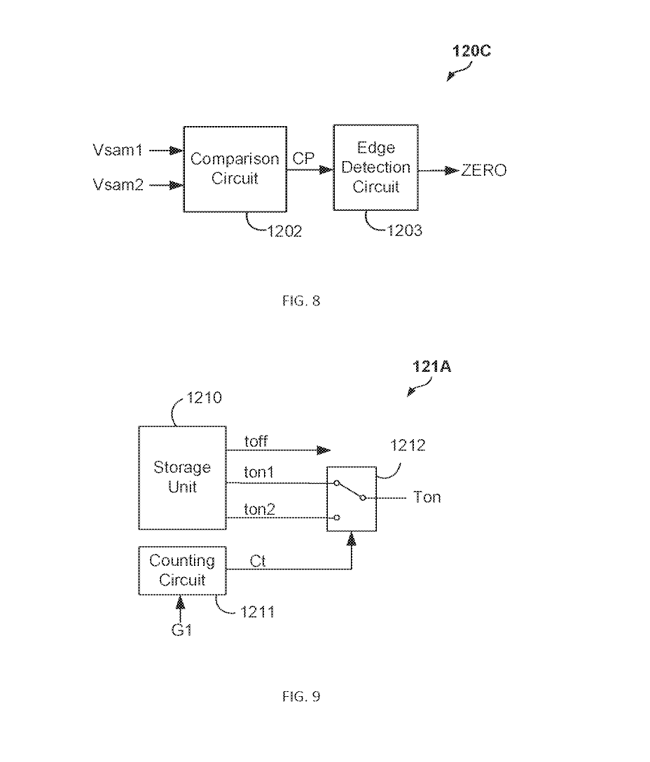

FIG. 8 illustrates a circuit schematic of a zero-crossing detection circuit 120C in accordance with another embodiment of the present invention. As shown in FIG. 8, the zero-crossing detection circuit 120C includes a comparison circuit 1202 and an edge detection circuit 1203. The comparison circuit 1202 is configured to receive the first sampling signal Vsam1 and the second sampling signal Vsam2, and to generate a comparison signal CP based on the first sampling signal Vsam1 and the second sampling signal Vsam2. In one embodiment, when the first sampling signal Vsam1 is higher than the second sampling signal Vsam2, the comparison signal CP is in the high level. In another embodiment, when the first sampling signal Vsam1 is lower than the second sampling signal Vsam2, the comparison signal CP is in the low level. The edge detection circuit 1203 receives the comparison signal CP and generates the zero-crossing indication signal ZERO based on the comparison signal CP. In one embodiment, when the AC input voltage Vac crosses zero from positive to negative, the first sampling signal V1 becomes lower than the second sampling signal Vsam2, the comparison signal CP transitions from the high level to the low level (i.e., a falling edge). The edge detection circuit 1203 detects the falling edge of the comparison signal CP and generates the zero-crossing indication signal ZERO in the high level to indicate that the AC input voltage Vac crosses zero. In another embodiment, when the AC input voltage Vac crosses zero from negative to positive, the first sampling signal Vsam1 becomes higher than the second sampling signal Vsam2, the comparison signal CP transitions from the low level to the high level (i.e., a rising edge). The edge detection circuit 1203 detects the rising edge of the comparison signal CP and generates the zero-crossing indication signal ZERO in the high level to indicate that the AC input voltage Vac crosses zero.

FIG. 9 illustrates a circuit schematic of an on time control circuit 121A in accordance with an embodiment of the present invention. As shown in FIG. 9, the on time control circuit 121A includes a storage unit 1210, a counting circuit 1211 and a selection circuit 1212. The storage unit 1210 is configured to store a plurality of preset on time values and off time values. In one embodiment, the storage unit 1210 stores a first on time ton1 (e.g., 50ns), a second on time ton2 (e.g., 100ns), and a plurality of on time values between the first on time ton1 and the second on time ton2 (e.g., 60ns, 70ns, 80ns).

The counting circuit 1211 receives the first control signal G1 and provides a counting signal Ct based on the first control signal G1. The counting signal Ct indicates the number of turn-on times of the first switch S1. For example, when first control signal G1 is in the high level, the first switch S1 is turned on, and the counting circuit 1211 can count once. In one embodiment, the counting signal Ct may be provided by detecting the number of times the first control signal G1 transitions to the high level. In another embodiment, the counting signal Ct may be provided by detecting the number of the rising edge of the first control signal G1.

The selection circuit 1212 receives the plurality of on time values stored in the storage unit 1210 and the counting signal Ct. The selection circuit 1212 can select different on time value as the on time signal Ton based on the counting signal Ct. In one embodiment, when the counting signal Ct indicates the number of turn-on times of the first switch S1 is less than a preset number (e.g., Ct <100), the selection circuit 1212 selects the first on time ton1 as the on time signal Ton. In another embodiment, when the counting signal Ct indicates the number of turn-on times of the first switch S1 exceeds the preset number (e.g., Ct >100), the selection circuit 1212 selects the second on time ton2 as the on time signal Ton.

FIG. 10 illustrates a circuit schematic of an on time control circuit 121B in accordance with another embodiment of the present invention. As shown in FIG. 10, the on time control circuit 121B includes a counting circuit 1213, a step control circuit 1214, an adder 1215 and a register 1216. The counting circuit 1213 is configured to receive the first control signal G1 and provide the counting signal Ct based on the first control signal G1. Where the counting signal Ct indicates the number of turn-on times of the first switch S1. The step control circuit 1214 is configured to provide a step signal Ton_step for controlling the increment value of the on time ton of the first switch S1 based on the counting signal Ct. In some embodiments, the on time ton of the first switch S1 increases by a fixed step value ton_step represented by the step signal Ton_step.

The adder 1215 adds the on time signal Ton(n) indicative of the on time of the current switching cycle to the step signal Ton_step and provides the on time signal Ton(n+1) indicative of the on time of the next switching cycle, i.e., Ton(n+1) = Ton(n) + Ton_step. The register 1216 receives and stores the on time signal Ton, where the initial on time signal in the register 1216 is the first on time signal Ton1. In some embodiments, the register 1216 is updated at the beginning of each switching cycle. In one embodiment, the register 1216 is updated when the rising edge of the first control signal G1 arrives. Those skilled in the art can understood that the switching cycle refers to the repetitive cycle of the first switch S1 being turned on and off. For example, the switching cycle can be the time period between the turn-on moment of the first switch S1 and the adjacent next turn-on moment of the first switch S1, or the time period between the turn-off moment of the first switch S1 and the adjacent next turn-off moment of the first switch S1.

In one embodiment, when the counting signal Ct is less than a first preset number (e.g., Ct <100), the step control circuit 1214 ceases providing the step signal Ton_step. The on time signal Ton provided by the register 1216 remains as the first on time signal Ton1. Consequently, the first control signal G1 controls the on time of the first switch S1 to be equal to the first on time ton1. In another embodiment, when the counting signal Ct is greater than the first preset number but less than a second preset number (e.g., 100<Ct<200), the step control circuit 1214 provides the step signal Ton_step, and the on time signal Ton provided by the register 1216 gradually increases. Consequently, the first control signal G1 controls the on time of the first switch S1 to increase gradually from the first on time ton1 to the second on time ton2 by the fixed step value ton_step represented by the step signal Ton_step. In yet another embodiment, when the counting signal Ct is greater than the second preset number (e.g., Ct>200), the step control circuit 1214 ceases providing the step signal Ton_step, and the on time signal Ton provided by the register 1216 remains at the second on time ton2. Consequently, the first on time control signal G1 controls the on time of the first switch S1 to be equal to the second on time ton2. In one embodiment, the step signal Ton_step is determined by the first on time signal Ton1, the second on time signal Ton2, the first preset number and the second preset number.

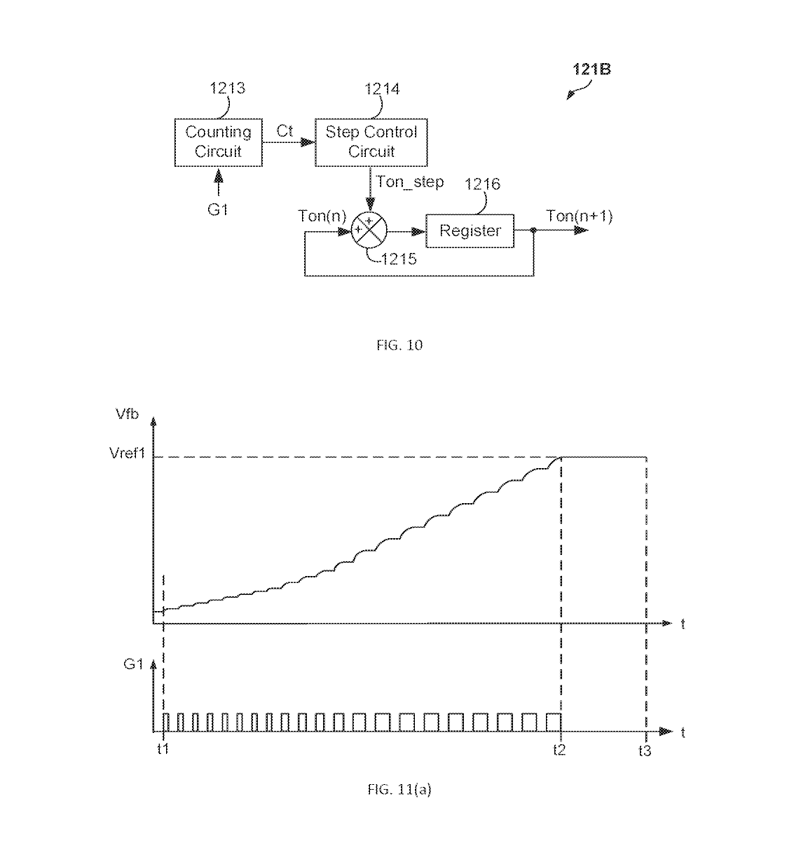

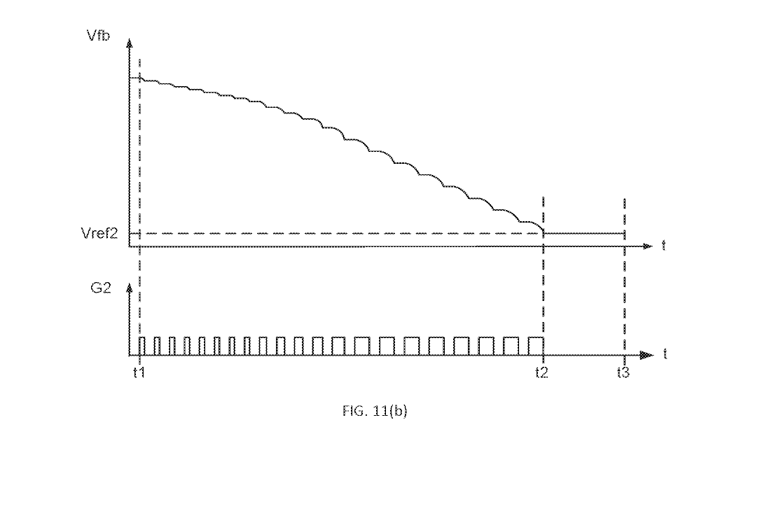

FIG. 11(a) illustrates a relationship diagram between the feedback signal Vfb indicative of the voltage at the switch node SW2 and the first control signal G1, when the totem pole PFC circuit 100A operates in the pre-conduction mode after the AC input voltage Vac crosses zero from positive to negative, in accordance with an embodiment of the present invention. As shown in FIG. 11(a), at time t1 (corresponding to time t41 in FIG. 5), the first switch S1 starts to be turned on multiple times to charge the switch node SW2. Each time the first control signal G1 is in the high level, the feedback signal Vfb increases. At time t2 (corresponding to time t44 in FIG. 5), the feedback signal Vfb increases to a first reference voltage Vref1, ceases charging the switch node SW2. At this time, the first control signal G1 switches to the low level, and the first switch S1 is turned off. In the example shown in FIG. 11(a), the longer the on time of the first switch S1, the greater the increment in the feedback signal Vfb. In one embodiment, the first reference voltage Vref1 represents the output voltage Vout. In one embodiment, the feedback signal Vfb gradually increases from the reference ground voltage (e.g., 0V) to the output voltage Vout (e.g., 400V) after time t1.

Similarly, FIG. 11(b) illustrates a relationship diagram between the feedback signal Vfb and the second control signal G2, when the totem pole PFC circuit 100A operates in the pre-conduction mode after the AC input voltage Vac crosses zero from negative to positive, in accordance with another embodiment of the present invention. As shown in FIG. 11(b), at time t1, the second switch S2 starts to be turned on multiple times to discharge the switch node SW2. Each time the second control signal G2 is in the high level, the feedback signal Vfb decreases. At time t2, the feedback signal Vfb decreases to a second reference voltage Vref2, ceases discharging the switch node SW2. At this time, the second control signal G2 switches to the low level, and the second switch S2 is turned off. In the example shown in FIG. 11(b), the longer the on time of the second switch S2, the greater the reduction quantity in the feedback signal Vfb. In one embodiment, the second reference voltage Vref2 represents the reference ground voltage. In one embodiment, the feedback signal Vfb gradually decreases from the output voltage Vout (e.g., 400V) to the reference ground voltage (e.g., 0V) after time t1.

Those skilled in the art can understand that the circuits in the above embodiments are used for illustration, not for limiting the present invention. Other suitable circuits capable of performing the functions and working processes of the circuits in the above embodiments do not depart from the spirit or scope of the present invention. For example, in some embodiments, the circuits in the embodiments of the present invention may be specifically described using digital description languages such as VHDL or Verilog, thereby automatically generating digital circuits to implement the corresponding functions.

Those skilled in the art can understand that the high level/low level of control signal is related to the type of the power switch. For example, if the power switch is N-type MOSFET, when the control signal is high level, the power switch is turned on; when the control signal is low level, the power switch is turned off. If the power switch is P-type MOSFET, when the control signal is high level, the power switch is turned off; when the control signal is low level, the power switch is turned on. The high level/low level of the control signals shown in the above embodiments are used for illustrative purposes, not used for limiting the present invention.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order in accordance with such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a totem pole PFC (power factor correction) circuit, the control circuit comprising:
an input voltage sampling terminal configured to receive a sampling signal indicative of an AC (alternating current) input voltage of the totem pole PFC circuit;
a zero-crossing detection circuit configured to determine whether the AC input voltage is in a zero-crossing interval based on the sampling signal and configured to generate a zero-crossing indication signal to indicate whether the AC input voltage crosses zero;
a control signal generator configured to receive the zero-crossing indication signal and configured to generate a first control signal; and
a first drive output terminal configured to provide the first control signal to a first switch of the totem pole PFC circuit; wherein
during a first time period after the AC input voltage crosses zero, the first control signal is configured to turn on the first switch multiple times with a first on time; and wherein
during a second time period after the AC input voltage crosses zero, the first control signal is configured to turn on the first switch multiple times with a second on time, wherein the second time period is after the first time period, and the second on time is longer than the first on time.

2. The control circuit of claim 1, wherein during a third time period after the AC input voltage crosses zero, the first control signal is configured to turn on the first switch with a third on time, wherein the third time period is between the first time period and the second time period, and wherein the third on time is longer than the first on time and shorter than the second on time.

3. The control circuit of claim 2, wherein during the third time period, the third on time gradually increases.

4. The control circuit of claim 2, wherein an off time of the first control signal during the first, second, and third time periods is a constant value.

5. The control circuit of claim 1, wherein the first on time is shorter than 1μs.

6. The control circuit of claim 1, wherein a switching frequency of the first control signal during the first time period is higher than 200kHz.

7. The control circuit of claim 1, wherein the sampling signal comprises a first sampling signal and a second sampling signal, and wherein the zero-crossing detection circuit comprises:
a multiplexer having a first input terminal, a second input terminal and an output terminal, wherein the first input terminal is configured to receive the first sampling signal and the second input terminal is configured to receive the second sampling signal, and the multiplexer is configured to provide the first sampling signal or the second sampling signal to the output terminal in a time-sharing manner;
an analog-to-digital converter coupled to the output terminal of the multiplexer and configured to convert the first sampling signal and the second sampling signal to a first digital signal and a second digital signal respectively; and
a digital processing unit coupled to the analog-to-digital converter and configured to provide the zero-crossing indication signal based on the first digital signal and the second digital signal.

8. The control circuit of claim 1, wherein the sampling signal comprises a first sampling signal and a second sampling signal, and wherein the zero-crossing detection circuit comprises:
a comparison circuit configured to receive the first sampling signal and the second sampling signal and configured to generate a comparison signal based on the first sampling signal and the second sampling signal; and
an edge detection circuit configured to receive the comparison signal and configured to generate the zero-crossing indication signal based on the comparison signal.

9. The control circuit of claim 1, further comprising:
an on time control circuit configured to provide an on time signal and an off time signal; wherein
the control signal generator is further configured to receive the on time signal and the off time signal, wherein after the AC input voltage crosses zero, the control signal generator is configured to generate the first control signal based on the on time signal and the off time signal.

10. The control circuit of claim 9, wherein the on time control circuit comprises:
a counting circuit configured to receive the first control signal and configured to provide a counting signal indicative of a number of turn-on times based on the first control signal; and
a selection circuit configured to receive the first on time, the second on time and the counting signal, wherein when the number of turn-on times is less than a preset number, the selection circuit is configured to select the first on time as the on time signal, and wherein when the number of turn-on times is greater than the preset number, the selection circuit is configured to select the second on time as the on time signal.

11. The control circuit of claim 9, wherein the on time control circuit comprises:
a counting circuit configured to receive the first control signal and configured to provide a counting signal indicative of a number of turn-on times based on the first control signal;
a step control circuit configured to provide a step signal based on the counting signal;
an adder configured to add the on time signal of a current switching cycle to the step signal and configured provide the on time signal of a next switching cycle; and
a register configured to receive and store the on time signal, wherein an initial value in the register is equal to the first on time.

12. The control circuit of claim 1, wherein during the zero-crossing interval, the first control signal is configured to keep the first switch off when a number of turn-on times reaches a preset number.

13. The control circuit of claim 1, further comprising:
a detection terminal configured to receive a feedback signal indicative of a voltage at a switch node of a half-bridge of the totem pole PFC circuit; wherein
the control signal generator is further configured to receive the feedback signal, wherein during the zero-crossing interval, when the feedback signal reaches a reference voltage, the first control signal is configured to keep the first switch off.

14. A control circuit for a totem pole PFC circuit, the control circuit comprising:
an input voltage sampling terminal configured to receive a sampling signal indicative of an AC input voltage of the totem pole PFC circuit;
a zero-crossing detection circuit configured to determine whether the AC input voltage is in a zero-crossing interval based on the sampling signal and configured to generate a zero-crossing indication signal to indicate whether the AC input voltage crosses zero;
a control signal generator configured to receive the zero-crossing indication signal and configured to generate a first control signal; and
a first drive output terminal configured to provide the first control signal to a first switch of the totem pole PFC circuit; wherein
during a first time period after the AC input voltage crosses zero, the first control signal is configured to turn on the first switch multiple times with a first switching frequency; and wherein
during a second time period after the AC input voltage crosses zero, the first control signal is configured to turn on the first switch multiple times with a second switching frequency, wherein the second time period is after the first time period, and the second switching frequency is lower than the first switching frequency.

15. The control circuit of claim 14, wherein during a third time period after the AC input voltage crosses zero, the first control signal is configured to turn on the first switch with a third switching frequency, wherein the third time period is between the first time period and the second time period, and wherein the third switching frequency is lower than the first switching frequency and higher than the second switching frequency.

16. The control circuit of claim 14, wherein an off time of the first control signal during the first, second, and third time periods is a constant value.

17. The control circuit of claim 14, wherein the first switching frequency is higher than 200kHz.

18. A totem pole PFC circuit, comprising:
a first half-bridge and a second half-bridge both coupled between an output terminal and a reference ground, wherein the first half-bridge includes a first switch and a second switch, and the second half-bridge includes a third switch and a fourth switch;
an inductor coupled between a switch node of the first half-bridge and a first input terminal of the totem pole PFC circuit;
a zero-crossing detection circuit configured to determine whether an AC input voltage of the totem pole PFC circuit is in a zero-crossing interval based on a sampling signal indicative of the AC input voltage and configured to generate a zero-crossing indication signal to indicate whether the AC input voltage crosses zero; and
a control signal generator configured to receive the zero-crossing indication signal and configured to generate a first control signal and a second control signal to control the first switch and the second switch respectively; wherein
during a first time period after the AC input voltage crosses zero, the first control signal is configured to turn on the first switch multiple times with a first on time; and wherein
during a second time period after the AC input voltage crosses zero, the first control signal is configured to turn on the first switch multiple times with a second on time, wherein the second time period is after the first time period, and the second on time is longer than the first on time.

19. The totem pole PFC circuit of claim 18, wherein during a third time period after the AC input voltage crosses zero, the first control signal is configured to turn on the first switch with a third on time, wherein the third time period is between the first time period and the second time period, and wherein the third on time is longer than the first on time and shorter than the second on time.

20. The totem pole PFC circuit of claim 19, wherein during the third time period, the third on time gradually increases.
